(19) United States
(12) Patent Application Publication
(10) Pub. No.: US 2004/0150345 A1
(43) Pub. Date: Aug. 5, 2004

(54) Gas discharge lamp

(76) Inventors: Robert Peter Scholl, Roetgen (DE); Rainer Hilbig, Aachen (DE); Achim Koerber, Kerkrade (DE); Johannes Baier, Wuerselen (DE)

Correspondence Address: US Philips Corporation, Intellectual Property Department, P O Box 3001, Briarcliff Manor, NY, 10510, US

(21) Appl. No.: 10/479,557

(22) PCT Filed: Jun. 6, 2002
(86) PCT No.: PCT/IB02/02085

(30) Foreign Application Priority Data
Jun. 8, 2001 (DE) 101 27 961.2

(51) Int. Cl. H01J 17/20

(52) U.S. Cl. 313/637

(57) ABSTRACT

A gas discharge lamp is described with a discharge gas comprising a light-emitting substance enclosed in a discharge vessel, which is characterized in particular in that the light-emitting substance is formed by a compound of at least one element from the group IV-A (Si, Ge, Sn, Pb) and at least one element from the group VI-A (O, S, Se, and Te) of the periodic system, with the exception of the compound GeSe. It was surprisingly found that the emission maximum lies approximately in the center of the visible spectral range of the light with such a substance, in particular GeTe, at a comparatively low vapor pressure already, and that in addition a very high radiant efficacy is obtained. Furthermore, the emitted light has a color temperature substantially corresponding to that of natural daylight also without additives, in contrast to many other gas discharge lamps, thus opening the way to a use of the lamp for general lighting purposes.

The invention relates to a gas discharge lamp with a discharge gas comprising a light-emitting substance enclosed in a discharge vessel.

Such a gas discharge lamp is known from DE 22 25 308. The light-emitting substance in which the discharge takes place is germanium selenide in this lamp, which substance is introduced into the discharge vessel in the form of its component elements germanium and selenium and is present as a vapor in the operational state of the lamp.

A disadvantage of this lamp is, however, that the generated radiation has a very high color temperature, so that it is usually not suitable for general lighting purposes. Further substances are to be introduced into the discharge vessel for this application, which substances generate a substantial emission in the range of longer wavelengths of visible light. These substances may be, for example, tin and at least one halogen, for which, however, certain mixing ratios are to be observed with the dual purpose of generating a sufficient radiation portion for shifting the color temperature and also for not jeopardizing a stable lamp operation. In addition, these substances also influence the required quantities or mixing ratios of germanium and selenium, so that the manufacture of such a lamp may be very complicated because of these numerous parameters.

It is accordingly an object of the invention to provide a gas discharge lamp of the kind mentioned in the opening paragraph with which it is possible in a simpler manner to generate a light radiation which is also suitable for general lighting purposes, in particular as regards its (low) color temperature.

Furthermore, a gas discharge lamp is to be provided whose luminous efficacy or other lamp parameters such as color rendering index can be adjusted to a desired value in a simple manner.

These objects are achieved by means of a gas discharge lamp with a discharge gas comprising a light-emitting substance enclosed in a discharge vessel, which is characterized, according to claim 1, in that the light-emitting substance is formed by a compound of at least one element from the group IV-A (Si, Ge, Sn, Pb) as well as at least one element from the group VI-A (O, S, Se, and Te) of the periodic system, with the exception of the compound GeSe.

A major advantage of this solution is that several lamp parameters can be optimized also without further additives, depending on the choice of the elements.

The dependent claims relate to advantageous further embodiments of the invention.

It is possible with the embodiments as defined in claims 2 to 4 to generate light with a color temperature which substantially corresponds to that of natural daylight, so that such a lamp is particularly suitable for general lighting purposes.

Furthermore, a very high radiant efficacy is achieved thereby, and the low saturation vapor pressure of germanium telluride also improves the (re-)ignition behavior, the stability of the discharge, and lamp life to a decisive degree.

It was finally found that, in particular in this embodiment, the electric power may be supplied not only in an electrodeless manner by means of an electromagnetic AC field in the high-frequency or microwave range, but also by means of conventional metal, and in particular tungsten electrodes because of the comparatively low reactivity (in particular of GeTe).

Claims 3 and 4 indicate preferred quantities and mixing ratios of the elements forming the light-emitting substance for a reliable lamp operation, while claims 5 and 6 describe a preferred starting gas and the quantity thereof.

The dimensioning in accordance with claim 7, finally, achieves particularly good lamp characteristics and performance.

The color rendering properties of the lamp can be positively influenced in particular in the embodiment as claimed in claim 8.

It should be noted here that a mercury vapor lamp is known from JP-A-32 007 247 in which a fine powder of several materials is introduced into the discharge vessel in addition to the discharge gas. This material is heated by the discharge, is distributed in the vessel by the gas flow, and subsequently generates a selective radiation which is to have a positive influence on the overall spectrum of the emitted light. The added material is formed by oxides of elements from groups I, II, I, or IV, as well as elements of groups V, VI, or VII, such that this material is chosen in dependence on the desired spectrum of the additional selective radiation. Apart from the fact that a shift in the spectrum is achieved by means of additives also in this lamp, similar to the prior art mentioned above, this lamp is not relevant to the present invention because the light-emitting substance belongs to a completely different chemical group.

Further particulars, features, and advantages of the invention will become apparent from the following description of preferred embodiments of the invention in conjunction with the drawing, in which:

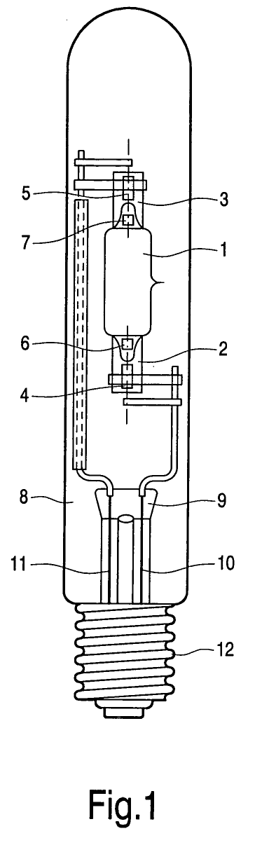

FIG. 1 diagrammatically shows a gas discharge lamp according to the invention;

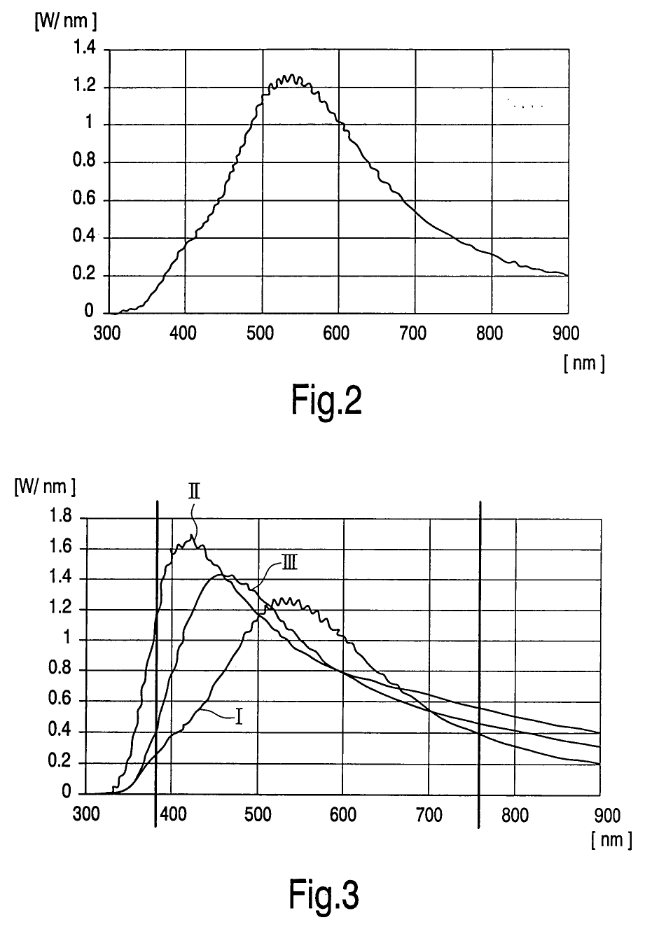

FIG. 2 shows a wavelength spectrum of the light generated by this lamp; and

FIG. 3 shows wavelength spectra of gas discharge lamps with different gas fillings.

FIG. 1 diagrammatically shows a possible embodiment of a high-pressure gas discharge lamp which can be operated with the discharge gas according to the invention. The lamp comprises a quartz glass discharge vessel 1 in which the discharge gas is present. Tungsten electrodes 6, 7 are provided for exciting a discharge. The current is supplied through current supply elements 4, 5 which are passed through respective pinches 2, 3 at mutually opposed ends of the discharge vessel 1 and are connected to the tungsten electrodes 6, 7. All these elements are surrounded by an outer envelope 8 which has a pinch 9 at one end through which the vacuumtight current supply wires 10, 11 extend. These wires 10, 11 connect a conventional screw base 12 at the outer envelope 8 to the current supply elements 4, 5.

In an alternative embodiment of the lamp, the power may be supplied without electrodes by means of a device for coupling HF or microwave radiation (for example a microwave resonator), by means of which an electromagnetic AC field in the high-frequency or microwave range is generated so as to traverse the discharge gas.

The discharge vessel 1 contains the discharge gas which comprises besides a rare gas serving as a starting gas, for example argon, and possibly a buffer gas such as, for example, mercury, a compound of at least one element from the group IV-A (Si, Ge, Sn, Pb) and at least one element from the group VI-A (O, S, Se, Te) of the periodic system as the light-emitting substance, which compound is introduced into the discharge vessel in the form of its component elements.

Surprisingly advantageous properties can be achieved when the light-emitting substance is formed by germanium telluride (GeTe). Germanium and tellurium are for this purpose introduced into the discharge vessel in a quantity of each at least approximately 0.1 μmole per cm³ of volume of the vessel. To avoid an excessive formation of Te₂, the molar ratio between germanium and tellurium is chosen to be greater than approximately 0.25. If this ratio is above 1, a solid quantity of germanium will remain at the bottom until the gas composition has again assumed a molar ratio of approximately 1 again. The material of the discharge vessel may be quartz (SiO₂), densely sintered aluminum oxide (Al₂O₃), or other oxidic ceramic materials.

Relevant measurements were carried out with such a (first) embodiment in which approximately 12.6 mg germanium (=173 μmole) and approximately 22.1 mg tellurium (=166 μmole) were introduced into a spherical quartz discharge vessel with an internal diameter of approximately 32-33 mm, in addition to the starting gas argon with a cold pressure of approximately 100 mbar (=4.0 μmole/cm³). The gas discharge was generated by means of a microwave resonator at approximately 2.45 GHz. At a power dissipation of the complete system of lamp and resonator of approximately 800 W, a temperature of approximately 1200 K arises in the coldest spot of the discharge vessel, which corresponds to a saturation vapor pressure of approximately 0.2 bar of germanium telluride (GeTe).

The spectrum of the light generated by this first gas filling is shown in FIG. 2 and in FIG. 3, curve I, showing that the maximum of the emission lies substantially in the center of the visible spectral range of the light.

Assuming that a power loss of approximately 10% occurs in the microwave resonator owing to a current flow in the resonator wall, a luminous flux of 81.5 klm results for a plasma power of 720 W, i.e. a plasma efficacy of 113 lm/W. The generated light had a color temperature of approximately 5330 K, while the coordinates in the color triangle were x=0.3383 and y=0.3954, and the color rendering index Ra₈=84.9.

This first embodiment accordingly distinguishes itself by a particularly high efficacy of the light emission and a particularly low color temperature substantially corresponding to that of natural daylight. Furthermore, the concentration of germanium and chalcogenide in the gas phase is particularly low because of the low saturation vapor pressure of GeTe of approximately 0.2 bar. It was surprisingly found that the operating characteristics of such a lamp are very positively influenced thereby as regards its (re-)ignition behavior, the stability of the discharge, and lamp life. It is in particular the useful life of lamps with tungsten electrodes which is decisively prolonged by low partial pressures of germanium and chalcogenide. The reactivity of the chalcogenides with tungsten in fact shows a falling tendency starting from sulphur via selenium down to tellurium, so that in particular lamps with GeTe fillings can also be reliably operated with conventional metal electrodes such as, for example, tungsten electrodes.

The test results obtained in particular with this first embodiment are also surprising because, for example with the use of GeO as the light-emitting substance, the maximum of the emission lies at approximately 280 nm, and the spectrum does not extend far enough into the visible range for making the use of a GeO lamp practicable as a light source. Experiments have indeed shown that a shift to heavier Ge-chalcogenides, i.e. an increase in the molecular mass, also leads to a visible shift of the emission maximum to greater wavelengths. In addition, given a sufficiently higher concentration of the Ge-chalcogenide in the gas phase, a self-absorption of the short-wave radiation of the band system takes place, so that the emission maximum lies above the band head and shifts further in the direction of greater wavelengths with a rising Ge-chalcogenide pressure.

On the other hand, however, the transition from the lighter to the heavier Ge-chalcogenides leads to the additional problem that the vapor pressures decrease strongly, with the exception of GeO. Since the maximum temperature of a quartz glass discharge vessel must remain below the softening or crystallization point of approximately 1400 K, the coldest spot of the vessel must not become substantially hotter than approximately 1200 K in the practical application. At this temperature, however, the vapor pressure is very low, in particular of GeTe with 0.2 bar (GeO: 30 mbar, GeS: 20 bar, GeSe: 2 bar), so that it was not to be expected for the discharge at such a low vapor pressure that the emission maximum already lies approximately in the center of the visible range of the light and has such a high radiant efficacy (113 lm/W).

It was further demonstrated that good values for the plasma efficacies and color temperatures could be achieved also with other Ge-chalcogenides when the molar ratio of the chalcogen (group VI-A) to metal (group IV-A) introduced into the discharge vessel is below 2, a ratio of 1:1 being preferably chosen, so that a sufficient quantity of chalcogenide will enter the gas phase.

In a second embodiment, a spherical discharge vessel with an internal diameter of approximately 32-33 mm was filled with approximately 32.7 mg germanium (=450 μmole) and approximately 13.5 mg sulphur (=433 μmole) in addition to the starting gas argon with a cold pressure of approximately 100 mbar (=4.0 μmole/cm³). The gas discharge was generated by means of a microwave resonator at approximately 2.45 GHz. The entire quantity of GeS was in the vapor state for a power dissipation of the entire system of lamp and resonator of approximately 800 W, and a pressure of approximately 5.6 bar arose in the discharge vessel.

The spectrum of the light generated with this second gas filling is shown in FIG. 3, curve II, from which it is apparent that the maximum of the emission has clearly shifted in the direction of shorter wavelengths as compared with that of GeTe.

Assuming that a power loss of approximately 10% occurs in the microwave resonator owing to a current flow in the resonator wall, a plasma power of 720 W leads to a luminous flux of 66.9 klm, i.e. a plasma efficacy of 93 lm/W. The generated light had a color temperature of approximately 10,870 K, the coordinates in the color triangle were x=0.2790 and y=0.2784, and the color rendering index Ra₈=93.7.

In a third embodiment, a spherical discharge vessel with an internal diameter of approximately 32-33 mm was again filled with approximately 32.7 mg germanium (=450 μmole) and approximately 34.2 mg selenium (=433 μmole) in addition to the starting gas argon with a cold pressure of approximately 100 mbar (=4.0 μmole/cm³). The gas discharge was generated by means of a microwave resonator at approximately 2.45 GHz. A power dissipation of the entire system of lamp and resonator of approximately 800 W led to a temperature of approximately 1200 K in the coldest spot of the discharge vessel, resulting in a saturation vapor pressure of approximately 2 bar GeSe.

The spectrum of the light generated with this third gas filling is shown in FIG. 3, curve III. The maximum of the emission lies between the maxima of the emissions of GeTe and GeS.

Assuming that a power loss of approximately 10% occurs again in the microwave resonator owing to a current flow in the resonator wall, a plasma power of 720 W leads to a luminous flux of 69.7 klm and a plasma efficacy of 97 lm/W. The generated light had a color temperature of approximately 9660 K, the coordinates in the color triangle were x=0.2783 and y=0.2992, and the color rendering index Ra₈=97.0 .

It was furthermore shown that the emission maximum for these embodiments shifts towards greater wavelengths with increasing power and accordingly with increasing wall temperature of the discharge vessel, which may be desirable for achieving a lower color temperature. To enhance this shift further, and also to increase the efficacy of the radiated light, three measures were found to be effective: an increase in the gas pressure inside the discharge vessel, an enlargement of the vessel diameter, and a reflection of radiation from the vessel walls back into the discharge space.

Overall, it is apparent from the above data and from FIG. 3 that particularly advantageous properties can be achieved by means of a lamp containing germanium telluride as the light-emitting substance (first embodiment).

It may be advantageous to add halogens, in particular when tin and lead chalcogenides are used, i.e. preferably with a molar ratio of metal (M) to chalcogen (C) to halogen (X) of 1 to 1 to 2, which corresponds to a compound MCX₂. The total vapor pressure in the discharge vessel is increased thereby.

It was finally found that all light-emitting substances mentioned above can be combined with conventional metal electrodes, for example made of tungsten, so that an excitation by means of high-frequency or microwave radiation is not absolutely necessary.

1. A gas discharge lamp with a discharge gas comprising a light-emitting substance enclosed in a discharge vessel, characterized in that the light-emitting substance is formed by a compound of at least one element from the group IV-A (Si, Ge, Sn, Pb) as well as at least one element from the group VI-A (O, S, Se, and Te) of the periodic system, with the exception of the compound GeSe.

2. A gas discharge lamp as claimed in claim 1, characterized in that the light- emitting substance is formed by germanium telluride (GeTe).

3. A gas discharge lamp as claimed in claim 2, characterized in that the germanium telluride is formed in the operational state of the lamp from germanium and tellurium which are introduced into the discharge vessel each in a quantity of at least approximately 0.1 μmole per cm³ of volume of said vessel.

4. A gas discharge lamp as claimed in claim 2, characterized in that the molar ratio of germanium to tellurium is above approximately 0.25.

5. A gas discharge lamp as claimed in claim 1, characterized in that the discharge gas comprises a rare gas such as argon as a starting gas.

6. A gas discharge lamp as claimed in claim 5, characterized in that the discharge vessel contains the starting gas at a cold pressure of approximately 100 mbar or in a quantity of approximately 4.0 μmole per cm³ of volume of the discharge vessel.

7. A gas discharge lamp as claimed in claim 1, characterized in that the discharge vessel is a substantially spherical quartz vessel.

8. A gas discharge lamp as claimed in claim 1, characterized in that the discharge gas comprises halogens, and in that the molar ratio of an element from the group IV-A to an element of the group VI-A to the halogen is approximately 1 to 1 to 2.

9. A gas discharge lamp as claimed in claim 1, characterized in that metal electrodes or a device for coupling HF or microwave radiation, by means of which an electromagnetic AC field in the high-frequency or microwave range traversing the discharge gas can be generated, are or is provided for the supply of electric power.
